(19) United States
(12) Patent Application Publication
(10) Pub. No.: US 2011/0208850 A1
(43) Pub. Date: Aug. 25, 2011

(54) SYSTEMS FOR AND METHODS OF WEB PRIVACY PROTECTION

(75) Inventors: Daniel G. Sheleheda, Florham Park, NJ (US); Edward G. Amoroso, Andover, NJ (US); Cynthia Cama, Belmar, NJ (US); John Donovan, Saratoga, CA (US); Balachander Krishnamurthy, New York, NY (US); William O'Hern, Spring Lake, NJ (US)

(73) Assignee: AT&T Intellectual Property I, L.P., Reno, NV (US)

(21) Appl. No.: 12/712,962

(22) Filed: Feb. 25, 2010

(51) Int. Cl. G06F 15/173

(52) U.S. Cl. 709/223

(57) ABSTRACT

A disclosed method for implementing anti-tracking measures for a web browser includes refreshing anti-tracking data structure responsive to satisfying at least one of a set of anti-tracking refresh criteria. The anti-tracking data structure may include opt-out cookie data indicative of a set of opt-out cookies, uniform resource locator (URL) anti-tracking data indicative of a set of URLs associated with URL tracking, and Referer header field anti-tracking data indicative of a set of URLs susceptible to Referer header field tracking. Responsive to a web browser of a user device generating a request for a third-party web page specified by a browser URL, at least a portion of the browser URL is compared against the anti-tracking data structure. If a match in the URL anti-tracking data or the Referer header field anti-tracking data is detected, the browser URL may be modified. The refreshing of anti-tracking data may include pulling a current anti-tracking data structure from an anti-tracking server. Alternatively, the current anti-tracking data structure may be pushed from the anti-tracking server.

### BACKGROUND

1. Field of the Disclosure

The present disclosure relates to the World Wide Web and, more particularly, techniques for enhancing privacy for web users including the prevention of web tracking

2. Description of the Related Art

Various forms of web tracking technology are used to gather data indicative of a user's web behavior and/or use patterns. Web aggregation companies collect web tracking information in ways that may be transparent or unknown to the user. Tracking information is used for purposes including user profiling to enable targeted advertising as well as statistical information regarding the visits to various web sites.

### BRIEF DESCRIPTION OF THE DRAWINGS

FIG. 1 is a block diagram of selected elements of an embodiment of a network including elements employing disclosed anti-tracking features;

FIG. 2 is a block diagram of selected elements of an embodiment of an anti-tracking client application;

FIG. 3 is a flow diagram of an embodiment of a disclosed anti-tracking method emphasizing opt-out cookies;

FIG. 4 is a flow diagram of an embodiment of a disclosed anti-tracking method emphasizing uniform resource locator (URL) tracking;

FIG. 5 is a flow diagram of an embodiment of a disclosed anti-tracking method emphasizing Referer (sic) header field tracking;

FIG. 6 is a flow diagram of an embodiment of a disclosed anti-tracking method emphasizing a server-side anti-tracking application;

FIG. 7A is a block diagram of selected elements of an embodiment of an exemplary user device for a fixed-media network; and

FIG. 7B is a block diagram of selected elements of an embodiment of an exemplary mobile user device for a wireless network.

### DESCRIPTION OF THE EMBODIMENT(S)

Web browsing activity is often tracked by online advertising companies or web aggregators. Web tracking may be and often is done in a manner where communications to the web aggregator may occur without the user being aware of them. Web aggregators use web tracking information for purposes including profiling users to provide targeted advertising and to gather statistics that are used to provide performance measurements back to the web site owners. Web tracking may be accomplished using a variety of techniques including, as examples, web browser cookies, programs or scripts that generate hypertext transfer protocol (HTTP) requests that provide specific information about the user, and mining information from one or more header fields in HTTP requests. The subject matter disclosed herein is intended to improve the ability of web users to protect their privacy by managing tracking information sent to web aggregators. The disclosed methods and systems are designed to work in an automated manner so that an average user does not require any advanced knowledge to implement the anti-tracking protections disclosed.

A user device and an associated service and method are disclosed where the user device includes a processor, a tangible computer readable storage medium accessible to the processor, and executable instructions, contained in the storage medium, for refreshing, from time to time, anti-tracking data stored on the user device, monitoring requests, e.g., HTTP requests, generated by a user device web browser, and modifying at least a portion of generated requests when a match between at least a portion of a request and the anti-tracking data is detected. The anti-tracking data may include URL tracking data indicative of web sites that participate in URL tracking. Modifying the request may include modifying a portion of a generated request to remove personally identifiable information. Monitoring may include monitoring a domain portion of the request indicating a domain for a match against domains indicated in the URL tracking data and/or monitoring a query portion of the request for a match against regular expression pattern(s) defined in the URL tracking data. The regular expression pattern definitions may define character string patterns that would be found in URL strings used by a web aggregator to track the user's visit to a site as discussed in greater detail below. The anti-tracking data may include Referer (sic) header field tracking data indicative of web sites that participate in Referer header field tracking. In this case, modifying a request may include modifying a Referer header field of the request to remove personally identifiable information contained in the Referer header field. (It is noted that “Referer” is the HTTP protocol specification spelling, see, e.g., Internet Engineering Task Force (IETF) Request For Comment (RFC) 2616 Hypertext Transfer Protocol—HTTP 1.1 [hereinafter “RFC 2616”], Section 14.36. To maintain consistency with the protocol specification, the term “Referer header field” is used herein when referring to the header field.

In another aspect, a disclosed method for implementing anti-tracking measures includes refreshing anti-tracking data contained in an anti-tracking data structure if at least one of a set of anti-tracking refresh criteria is satisfied. The anti-tracking data structure contains anti-tracking data that may include opt-out cookie data indicative of a set of opt-out cookies, URL anti-tracking data indicative of a set of URLs associated with URL tracking, and Referer header field anti-tracking data indicative of a set of URLs susceptible to Referer header field tracking. When a user device web browser generates a request for a third-party web page specified by a browser URL, at least a portion of the request is compared against information contained in the anti-tracking data. If a match between the request and the anti-tracking data is detected, the request may be modified. Refreshing the anti-tracking data may include pulling current anti-tracking data from an anti-tracking server. Alternatively, the current anti-tracking data structure may be pushed from the anti-tracking server to the user device.

In the following description, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

In one aspect, disclosed embodiments automate the storage of consumer opt-out cookies (opt-out cookies) to browser-accessible storage of a user device and the periodic maintenance of the opt-out cookies. Images or other objects contained in a web page may reside on a third party server that is different than the server that provides the web page. In order to process such a web page, a web browser may retrieve all of the third-party objects. The process of retrieving a third-party object may result in a web browser cookie from the third-party server being stored on the browser's system. These cookies are referred to herein as third-party cookies.

The generation of third-party cookies is common practice in the field of on-line advertising. A web banner, for example, is typically provided from a server of the advertising company, which is typically not in the domain of the web pages showing them. If a browser's settings are not set to reject third-party cookies entirely, an advertising company can track a user across the sites where it has placed a banner. In particular, whenever a user views a page containing a banner, the browser retrieves the banner from a server of the advertising company. If this server has previously set a cookie, the browser sends the cookie back, allowing the advertising company to link this access with the previous one. By choosing a unique banner URL for every web page where it is placed or by using the HTTP Referer header field, the advertising company can then find out which pages the user has viewed. Thus, third-party cookies may be used to create an anonymous profile of the user that may allow an advertising company to provide targeted advertising to a user based on the user's profile.

Third-party cookies can also be generated using web bugs. Web bugs encompass various techniques used to track the identity of a user who is accessing a web page or accessing an e-mail message, when the access occurs, and information associated with the user's computer such as the computer's IP address or software running on the user's computer. Like banner ads, web bugs represent third-party content in a web page, i.e., content that is only accessible via the third-party's web page. When a web page includes a web bug that refers to third-party content, accessing the web page may cause the web browser to generate a request to the third-party. The third-party server may, if it has not previously done so, generate a cookie for storage on the user device.

Unlike banners ads, which are typically prominently displayed, a web bug may be a small, e.g., 1 pixel, image or other element embedded in the web page that may not be readily detectable by the user. In this manner, the third-party web server may receive a request from the browser that documents the browser's visit to a web page. These third-party requests typically include an internet protocol (IP) address corresponding to user device, the time the web bug content was requested, the type of web browser that made the request, and the existence of any cookies that the third-party server previously created. The third-party server can store all of this information and associate it with a unique number such as the tracking token attached to the content request.

Using anti-tracking functionality disclosed herein, opt-out cookies may be dynamically downloaded from a web aggregation site based on a control file that is systematically maintained. The ability to automatically and dynamically manage opt-out cookies improves on static cookie management techniques, e.g., such as completely disabling cookies or manually downloading consumer opt-out cookies. Disabling cookies entirely will generally have a negative impact on a user's browsing experience. Manual downloading of static opt-out cookies requires users to be vigilant to prevent opt-out cookie deletions, to detect opt-out cookie expirations, and to keep opt-out cookies current when web aggregators replace existing opt-out cookies with new or revised opt-out cookies. If any of these events occur, the user must repeat the process manually. Although efforts such as the Targeted Advertising Cookie Opt-Out (TACO) project are designed to address some aspects of the difficulty of manually maintaining a complete and current set of opt-out cookies, TACO is a “frozen cookie” technique, i.e., TACO fetches and installs statically defined cookies from a defined set of aggregator sites. The disclosed anti-tracking methods for opt-out cookies includes dynamic and automated downloading of opt-out cookies upon installation and updating as required or on-demand. Embodiments of the disclosed anti-tracking methods beneficially cause a user's browser to visit aggregator web sites and get “fresh cookies,” i.e., the most up-to-date opt-out cookies available. This may happen periodically and is necessary for certain sites that do not recognize frozen cookies.

Moreover, by leveraging certain anti-tracker detection methods disclosed herein, the anti-tracking described herein provides broader opt-out cookie coverage than static opt-out cookie approaches and supports a dynamic list of opt-out cookie sites that exceeds publically available listings such as the Network Advertising Initiative (NAI) listing.

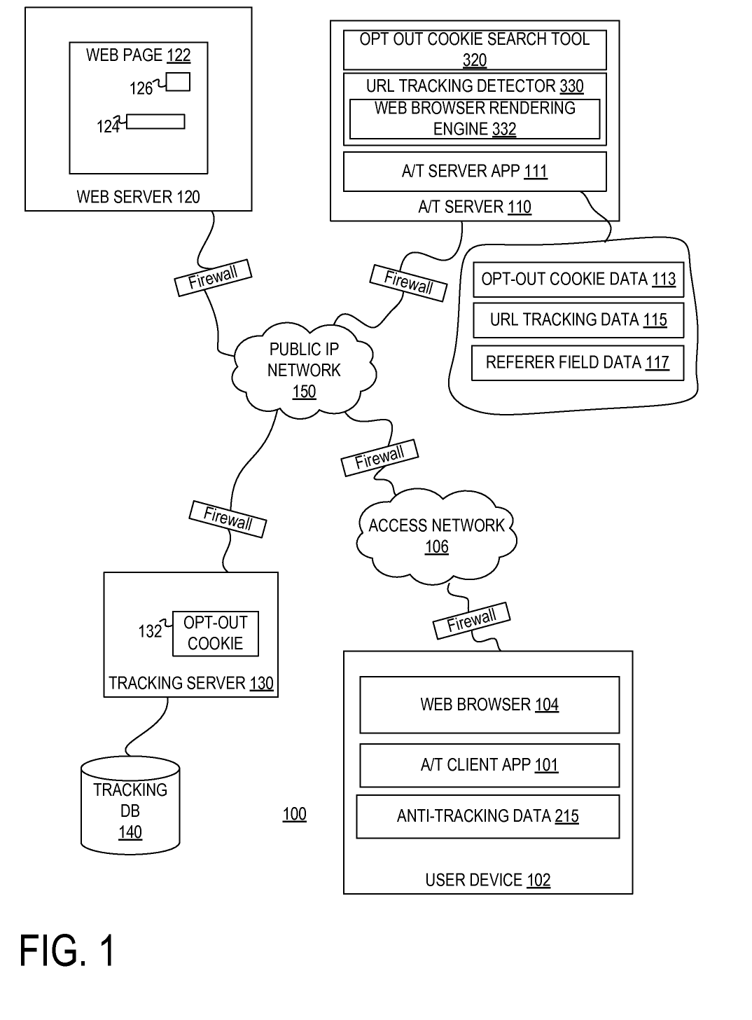

Referring now to the drawings, FIG. 1 is a block diagram of selected elements of a data network 100 emphasizing various anti-tracking features disclosed herein. Network 100 may include elements of traditional computer networks including servers, gateways, routers, repeaters, and so forth. Embodiments of network 100 may also include or support wireless and wireline connections and may include telecommunications elements enabling telephony-based devices to exchange information.

The elements of network 100 depicted in FIG. 1 include a user device 102, an anti-tracking (A/T) server 110, a web server 120, a tracking server 130, which embodies a conventional web aggregator, and a tracking database 140 that is accessible to tracking server 130, all configured to access an IP network 150. In the depicted embodiment, network 150 is a public IP network that may represent or include the Internet or any other IP network that does not impose access restrictions.

Tracking database 140 may be integrated within, local to, or remotely located with respect to tracking server 130. Moreover, although depicted as a single database, tracking database 140 may be distributed among multiple network resources and network 100 may include one or more cached copies (not depicted) of tracking database 140. In addition, tracking server 130 may include or have access to a database server (not depicted) that is configured to submit database queries to tracking database 140 on behalf of tracking server 130 and process the corresponding results.

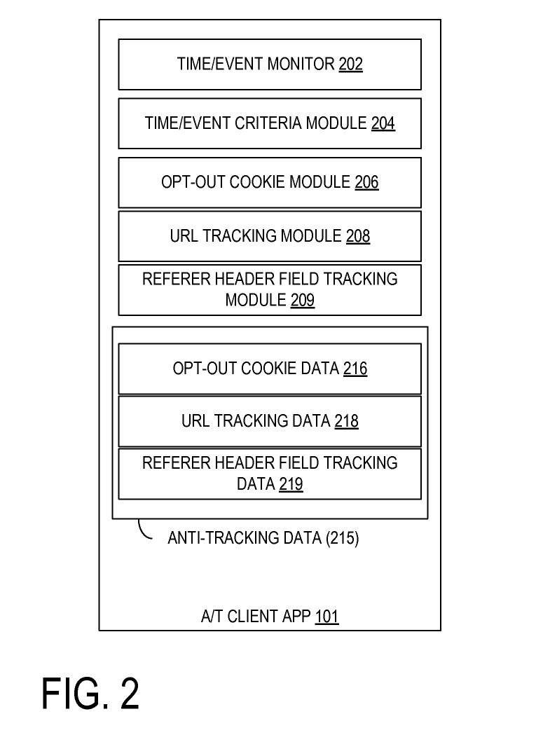

User device 102 as depicted in FIG. 1 encompasses any network-aware electronic device that is capable of executing an Internet browser application or another application that provides a graphical user interface configured to facilitate user communication with a web server. User device 102 as depicted in FIG. 1 includes a web browser 104, an A/T client application 101, described in greater detail below with respect to FIG. 2, and anti-tracking data 215.

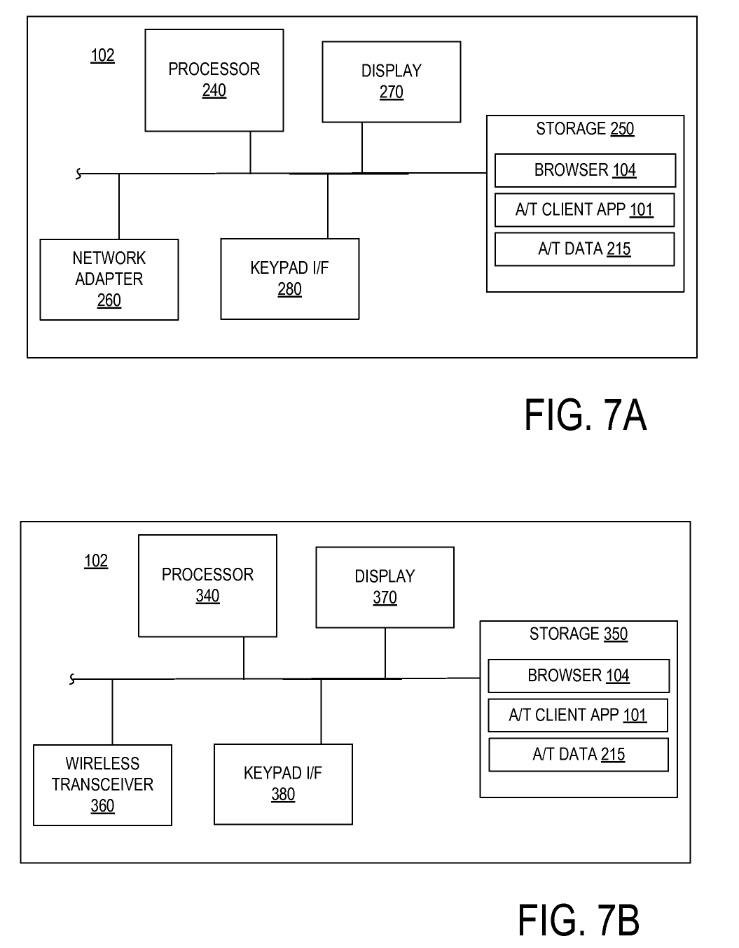

Embodiments of user device 102 are depicted in FIG. 7A and FIG. 7B. As depicted in FIG. 7A, some embodiments of user device 102 may be implemented as a desktop or laptop computer that includes a general purpose processor 240 and memory or other form of computer readable storage 250 that is accessible to processor 240 and capable of storing both data and instructions. In the depicted embodiment of user device 102, storage 250 contains instructions and data including a web browser 104, an A/T client application 101, and anti-tracking data 215. User device 102 as depicted in FIG. 7A further includes a network adapter 260, a display 270, which may represent a graphics adapter in combination with a display device, and a keypad interface 280 or other form of I/O device for accepting user input.

In other embodiments, including the embodiment depicted in FIG. 7B, user device 102 may be implemented as a mobile electronic device that includes a processor 340 and storage 350, a radio frequency (RF) module or other type of wireless transceiver 360, configured to enable user device 102 to communicate wirelessly with public IP network 150, a display 370, and a keypad interface 380. The mobile electronic device depicted in FIG. 7B may be embodied in any of various types of mobile devices including, as examples, smart phones, personal digital assistants (PDAs), handheld computers, and so forth. Like the embodiment depicted in FIG. 7A, the embodiment of user device 102 depicted in FIG. 7B also includes instructions for a web browser 104, a mobile embodiment of A/T client application 101, and tracking data 215.

Returning to the embodiment of network 100 depicted in FIG. 1, user device 102 accesses public IP network 150, through various firewalls indicated in FIG. 1, by way of an access network 106. Access network 106 may include or support any one or more of a variety of access media including twisted copper, fiber optic, co-axial cable, and wireless media. Access network 106 may include or support aspects of a fixed line access network employing, as an example, a broadband access network based on digital subscriber line (DSL), fiber to the premises (FTTP), co-axial cable, or another broadband, fixed line media. For embodiments in which user device 102 is a mobile electronic device, access network 106 may include aspects of a wireless cellular telecommunications network such as a third generation (3G) network, a fourth generation (4G) network, or a predecessor network including, as examples, global system for mobile communication (GSM) or general packet radio service (GPRS).

Web server 120 is representative of a large number of network nodes that provide network destinations for web browsers such as web browser 104. Web browser 104 formats and transmits an HTTP compliant request for a specific network accessible resource. Web server 120 delivers web pages, typically in the form of a hypertext markup language (HTML) document, and associated content including images and JavaScript® (Sun Microsystems, Inc.) or other form of executable code to web browser 104. If a browser's request is properly formatted and delivered, the web server addressed by the request responds by providing the content of the requested resource. Web server 120 may also support server-side scripting to provide dynamic content.

The embodiment of web server 120 depicted in FIG. 1 illustrates a web page 122 served by web server 120. Web page 122 may include conventional HTML elements including a hyperlink 124, text (not depicted), and so forth. Web page 122 as depicted in FIG. 1 further includes a tracking element 126. Tracking element 126 is configured to facilitate the delivery of tracking information to a third-party such as the tracking server 130 depicted in FIG. 1. Tracking element 126 might be a web bug or another form of tracking element. As discussed above, the term web bug encompasses any one of a number of relatively transparent techniques used to track web pages accessed by a browser such as web browser 104.

In the embodiment depicted in FIG. 1, user device 102 includes an anti-tracking application, identified as A/T client application 101, that implements one or more anti-tracking techniques or solutions. A/T client application 101 may be downloaded to user device 102 for local execution. In other embodiments, the anti-tracking features of A/T client application 101 may be implemented as a service hosted by A/T server 110. In these embodiments, anti-tracking modules may execute directly on A/T server 110, a proxy for A/T server 110, or in some other fashion. While the download and install implementation of A/T client application 101 is emphasized in the majority of the following description, hosted implementations and/or combinations of hosted and downloaded implementations are all intended to be within the scope of the claimed subject matter.

Referring now to FIG. 2, selected elements of an embodiment of A/T client application 101 are discussed. A/T client application 101 is configured to enable one or more automated anti-tracking techniques for user device 102. In the embodiment depicted in FIG. 2, A/T client application 101 includes a time/event monitor 202, a time/event criteria module 204, an opt-out cookie module 206, a URL tracking module 208 a Referer header field tracking module 209, and anti-tracking data 215 including opt-out cookie data 216, URL tracking data 218, and Referer header field tracking data 219.

Time/event monitor 202 implements functionality for detecting the expiration of a defined interval of time and/or the arrival of a defined date and time as well as detecting the occurrence of one or more defined events. In some embodiments, the detection of a defined time or event causes A/T client application 101 to perform an anti-tracking refresh procedure during which A/T client application 101 may update all or portions of one or more of the anti-tracking data structures 216, 218, and 219 in anti-tracking data 215. A user may invoke time/event criteria module 204 to define A/T refresh periods or intervals, A/T refresh dates, and A/T events. Examples of A/T refresh events include a system reset event and an A/T server update event, which may comprise a message to user device 102 indicating that A/T server 110 has updated one or more of its A/T data structures and/or modules. In some embodiments, A/T server 110 messages its clients when A/T updates occur and the clients are then responsible for downloading or otherwise retrieving or implementing the updated A/T material.

As suggested above, one aspect of disclosed anti-tracking methods includes the use of consumer opt-out browser cookies, also sometimes referred to as generic cookies, and generically referred to herein simply as opt-out cookies. In embodiments that incorporate opt-out cookie anti-tracking functionality, A/T client application 101 includes an opt-out cookie module 206 that is configured, in conjunction with A/T server application 111 and opt-out cookie data 216, to automate the acquisition and maintenance of opt-out cookies that are stored on user device 102. As depicted in FIG. 1, a third-party web site such as tracking server 130 may provide public access to an opt-out cookie 132 that, when downloaded to a user's computer and subsequently returned to tracking server 130 as part of an HTTP request from the user's computer, conveys no personally identifiable information to tracking server 130. Tracking server 130 may provide opt-out cookie 132 voluntarily or to comply with any existing or future regulations. If web browser 104 accesses tracking server 130, whether knowingly or not, via a user device 102 that contains a stored copy of opt-out cookie 132, tracking server 130 will receive opt-out cookie 132 from web browser 104 with the web request, which is typically, but not necessarily, in the form of a GET request as specified in RFC 2616 Section 5.1.1 and Section 9.3. Tracking server 130 will recognize the received opt-out cookie as part of the request from web browser 104 and will thereafter not attempt to store a non-generic, i.e., a personalized cookie, on user device 102.

The embodiment of A/T client application 101 depicted in FIG. 2 includes, within anti-tracking data 215, a data structure identified as opt-out cookie data 216, which contains the most recent and complete list of opt-out cookies available. Opt-out cookie data 216 may be contained in tangible and persistent storage of user device 102. A/T client application 101 may invoke opt-out cookie module 206 to refresh or otherwise update opt-out cookie data 216.

In some embodiments, opt-out cookie module 206 of A/T client application 101 refreshes opt-out cookie data 216 by downloading or otherwise accessing opt-out cookie data 113 maintained by A/T server application 111 on A/T server 110 as depicted in FIG. 1. Opt-out cookie data 113 and opt-out cookie data 216 may include actual opt-out cookies, URLs identifying the network location of actual opt-out cookies, or a combination of both. In implementations where opt-out cookie data 113 includes a set of URLs identifying the network locations of a set of opt-out cookies, opt-out cookie module 206 may refresh opt-out cookie data 216 by sequentially visiting the URLs listed in opt-out cookie data 113 and retrieving the corresponding opt-out cookies. Alternatively, opt-out cookie module 206 may download the URLs listed in opt-out cookie data 113 so that opt-out cookie data 216 itself includes the list of opt-out cookie URLs. In this implementation, opt-out cookie module 206 may refresh opt-out cookies “on-the-fly,” i.e., each time web browser 104 sends a request to the applicable web site.

In implementations where opt-out cookie data 113 includes actual opt-out cookies, opt-out cookie module 206 may refresh opt-out cookie data 216 by simply storing the cookies contained in opt-out cookie data 216 on the subscriber's user device 102. While “on-the-fly” refreshing of opt-out cookie data 216 ensures that subscribers have the “freshest” opt-out cookies available, the resulting latency may be unacceptable or undesirable and it may be preferable to update the opt-out cookies in batch fashion, by either downloading actual opt-out cookies from opt-out cookie data 113 or by executing a script to visit a set of opt-out cookie URLs contained in opt-out cookie data 113 and/or opt-out cookie data 216. A/T client application 101 may be configured to permit subscribers to define the manner in which their opt-out cookies are updated and A/T client application 101 may further enable a subscriber or other user to initiate manually an opt-out cookie update procedure.

The described embodiments of A/T client application 101 and opt-out cookie module 206 are configured to ensure that users are provided with the freshest set of opt-out cookies available. By having a recent and comprehensive set of opt-out cookies stored and maintained automatically on user device 102, the disclosed features of A/T client application 101 provide comprehensive opt-out cookie support.

Some embodiments of anti-tracking techniques disclosed herein are implemented as computer executable instructions that are contained in a tangible computer readable medium such as storage 250 depicted in FIG. 7A, storage 350 of FIG. 7B, or storage (not explicitly depicted) of A/T server 110. Any of these storage devices may include volatile computer memory as well as non-volatile storage. Portions of the instructions may reside in computer memory during execution while other portions may be stored on a hard disk or other form of nonvolatile storage. When executed by a processor, the instructions may perform a function such as any of the anti-tracking functions described herein. Some of the functionality embedded in these instructions are illustrated and disclosed in conjunction with flow diagrams discussed herein.

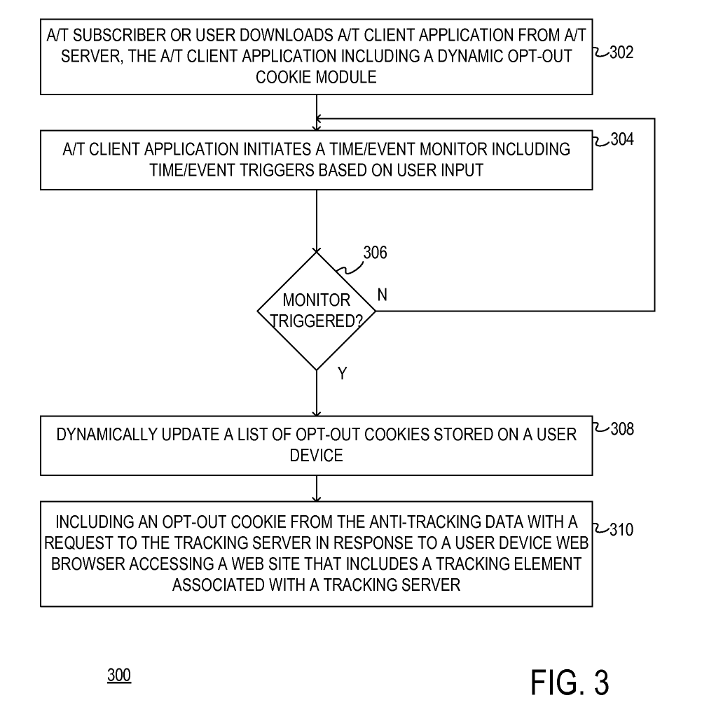

Referring now to FIG. 3, selected elements of an embodiment of opt-out cookie tracking module 206 are illustrated in flow diagram form as a method 300. The depicted embodiment of method 300 emphasizes the automated and dynamic acquisition and maintenance of a set of opt-out cookies on user device 102. Although the majority of the elements of method 300 depicted in FIG. 3 represent actions taken by user device 102, analogous actions may be performed by A/T server 110 in a network hosted implementation.

In the depicted embodiment of method 300, user device 102 downloads (block 302) from A/T server 110, or otherwise acquires, A/T client application 101 including opt-out cookie module 206 for execution on user device 102. In some embodiments, the downloading of A/T client application 101 is enabled only to registered users, A/T service subscribers, or is otherwise made contingent upon some form of registration with, authorization from, and/or subscription to anti-tracking services provided by A/T server 110.

A/T client application 101 as contemplated in FIG. 3 encompasses functionality for dynamically and automatically acquiring and refreshing anti-tracking data 215 including opt-out cookie data 216 reflecting the freshest opt-out cookies available. A/T client application 101 is further configured to monitor web requests generated by a user device web browser 104 and to modify the requests and/or incorporate opt-out cookies or other data from anti-tracking data 215 into the request.

As depicted in FIG. 3, opt-out cookie module 206 of A/T client application 101 initiates (block 304) a time/event monitor, e.g., time event monitor 202 of FIG. 2. Time/event monitor 202 may implement a clock, calendar, or other type of functionality for assisting A/T client application 101 in maintaining anti-tracking data 215 including opt-out cookie data 216, dynamically and in real time, on user device 102. Time/event monitor 202 may trigger A/T client application 101 to refresh, replace, or otherwise update anti-tracking data 215. As suggested by its name, time/event monitor 202 may trigger A/T client application 101 to refresh anti-tracking data 215 based, at least in part, on the passage of a specified period of time or the arrival of a specified time deadline. In addition, time/event monitor 202 may trigger A/T client application 101 based on the occurrence of one or more specified events. In this context, an event that might trigger time/event monitor 202 could be, for example, the discovery, by A/T server application 111, of the replacement or revision of an opt-out cookie 132 by tracking server 130 or the discovery of a new, previously unknown opt-out cookie 132.

The function of the time/event monitor 202 is captured in the decision block 306, where method 300 includes determining whether any defined deadline, time period, or event has occurred. A/T client application 101 as depicted in FIG. 2 includes a time/event criteria module 204 that is configured to enable a subscriber to define the timing criteria and/or events that trigger an opt-out cookie refresh. If the time/event monitor does not detect any triggering events, the depicted embodiment of method 300 continues to monitor for a triggering event or time. If, on the other hand, the time/event monitor detects a triggering event, method 300 branches to block 308 in which A/T client application 101 dynamically refreshes opt-out cookie data 216 on the user device 102 of a subscriber or other user.

As discussed above, the refreshing of opt-out cookie data 216 may include opt-out cookie module 206 of A/T client application 101 downloading opt-out cookie URLs listed in opt-out cookie data 113 into opt-out cookie data 216 or executing a script to retrieve opt-out cookies from the listed URLs and store the actual opt-out cookies in opt-out cookie data 216. Alternatively, opt-out cookie data 113 may store actual opt-out cookies and opt-out cookie module 206 of A/T client application 101 may access those opt-out cookies and download or otherwise store them in opt-out cookie data 216. Opt-out cookie module 206 of A/T client application 101 may be configured to store the opt-out cookies in a defined directory of user device 102. Opt-out cookie module 206 of A/T client application 101 may, as an example, store the opt-out cookies in a directory that web browser 104 defines as a cookie directory. In this manner, opt-out cookie module 206 of A/T client application 101 may transparently update the opt-out cookies of web browser 104.

FIG. 3 further illustrates a block 310 in which a user of web browser 104 browses to a web page that includes a tracking element that generates an HTTP request directed to tracking server 130. Assuming that tracking sever 130 offers an opt-out cookie and that A/T server 110 has discovered tracking server 130, opt-out cookie data 216 will either have the actual opt-out cookie of tracking server 130 stored locally, in which case browser 104 will include the opt-out cookie in the request or opt-out cookie data 216 will have a URL identifying the location of the actual opt-out cookie and opt-out cookie module 206 will acquire the opt-out cookie on-the-fly and incorporate the opt-out cookie into the request. When tracking server 130 receives the request with the opt-out cookie included, tracking server 130 will be aware of the user's desire not to be tracked and will respond accordingly. Thus, A/T client application 101, in conjunction with A/T server 110, is configured to automate the acquisition and maintenance of opt-out cookies for web browser 104 of user device 102.

A second aspect of disclosed anti-tracking techniques addresses URL tracking A web aggregation company, exemplified by tracking server 130 of FIG. 1, may use URL tracking to log or otherwise track browsing habits. As the term is used herein, URL tracking refers to the practice of configuring a web page to install, via a user's browser, a script or other form of executable code on the user's computer when the user browses to the web page. The script, when executed, generates a web request that forwards tracking information back to the aggregation company.

In some embodiments, A/T client application 101 includes a URL tracking module 208 to address URL tracking A/T client application 101 may, in conjunction with A/T server application 111 and URL tracking data 115 maintained by A/T server application 111, automate the acquisition and maintenance of URL tracking data 218 on user device 102. URL tracking data 218 may include URLs of web sites known to permit URL tracking URL tracking data 218 may further include information defining one or more regular expression patterns. URL tracking module 208 may monitor requests generated by browser 104. In some embodiments, URL tracking module 208 is configured to compare information in a web request against URL tracking data 218 and modify or block requests that match.

A/T server application 111 may systematically and dynamically maintain URL tracking data 115 and A/T client application 101 may download URL tracking data 115 to URL tracking data 218 during a refresh of A/T data 215. URL tracking data 115 may include a “blacklist” of URLs associated with URL tracking, a set of regular expression pattern definitions and a “whitelist” via which the user or service provider may define exceptions to the disclosed URL anti-tracking techniques. The regular expression pattern definitions may define character string patterns that would be found in URL strings used by a web aggregator to track the user's visit to a site. These pattern definitions may extend beyond simple domain name management and allow for wildcarding and similar functions.

Thus, disclosed embodiments of A/T client application 101 include support for addressing URL tracking using URL blacklists in conjunction with regular expression pattern definitions and whitelist exceptions. The regular expression pattern definitions may be used to modify “hidden” web requests, e.g., by removing the portion of a regular expression that enables URL tracking. The URL tracking data 218 is dynamically updated as required.

Referring back to FIG. 1, the depicted embodiment of A/T server application 111 stores or has access to a data structure identified as URL tracking data 115, which may include a URL tracking blacklist, a URL tracking whitelist, and a set of regular expression pattern definitions. The pattern definitions may identify domains that are suspected to be domains for a tracking server such as tracking server 130. In addition, the pattern definitions may specify regular expressions that may be used by tracking servers in conjunction with the domain portions.

The tracking element 126 on web page 122 provided by web server 120 may include, instead of or in addition to a tracking pixel, a JavaScript element that, when executed by web browser 104, causes web browser 104 to generate an HTTP request that is formatted to include, in addition to a domain name associated with tracking server 130, a URL expression that includes tracking information. For example, tracking element 126 may include JavaScript code that causes web browser 104 to generate an HTTP request of the form:
HTTP://hidden.com?u=pii, x=tracking info.

This request includes a domain portion containing the domain name “hidden.com” as well as a query portion containing a regular expression of the form “?u=pii, x=tracking info”. The pattern definitions in URL tracking data 115 and URL tracking data 218 may define character string patterns that would detect this request as a tracking request, i.e., a request primarily designed to provide tracking server 130 with data that is indicative of the browsing habits of web browser 104. URL tracking module 208 may be configured to recognize a specified and dynamically updated set of domain names as well as a defined set of regular expressions. As an example, URL tracking module 208 may be configured to flag any HTTP request that includes a domain name matching a domain name in the blacklist of URL tracking data 218 coupled with a regular expression that fits a regular expression pattern defined in URL tracking data 218. If, for example, a pattern definition in URL tracking data 218 defines any expression that begins with a “?” as a regular expression, then URL tracking module 208 in A/T client application 101, would detect the above illustrated request as a tracking request (assuming the domain hidden.com is on the list of domains in the blacklist of URL tracking data 218 and any whitelist therein does not provide an exception). URL tracking module 208 monitors requests generated by web browser 104 and would block or modify the detected request as a tracking request. Modification of the request might, for example, include removing the portion of the regular expression that matches the pattern definition before the request is transmitted from user device 102.

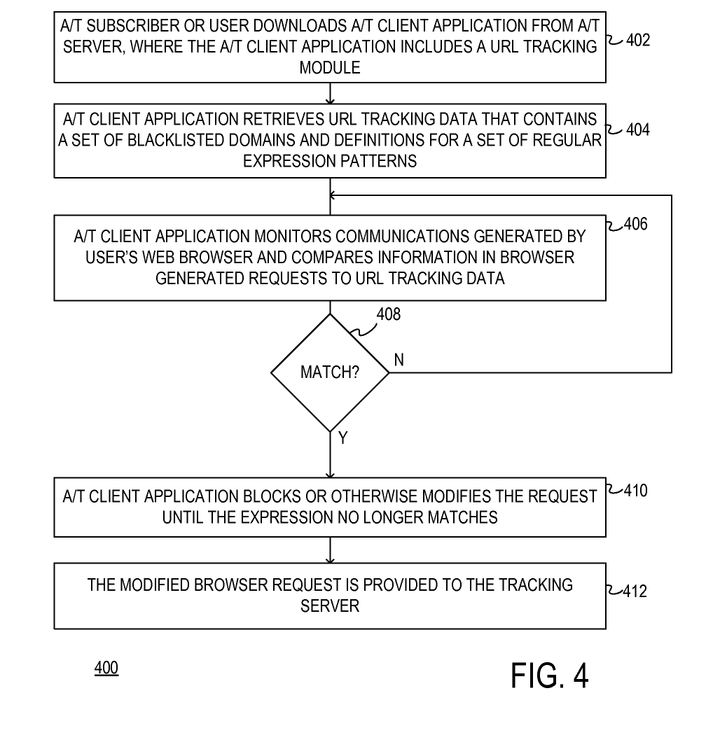

Referring now to FIG. 4, selected elements of an embodiment of a method 400 for addressing URL tracking are depicted. In the depicted embodiment, method 400 includes a user downloading (block 402) A/T client application 101 from A/T server 110, where A/T client application 101 includes a URL tracking module 208. In the depicted embodiment, A/T client application 101 retrieves (block 404) URL tracking data 115 from A/T server 110 and stores the URL tracking data as URL tracking data 218 on user device 102. URL tracking data 218 may include a set of blacklisted domains and a set of regular expression pattern definitions. URL tracking module 208 of A/T client application 101 may monitor (block 406) communications generated by user device web browser 104 and compare URLs and other information, e.g., header field information, contained in browser generated requests to information in URL tracking data 218. If URL tracking module 208 detects a match between a browser generated URL based on URL tracking data 218, as determined in block 408, URL tracking module 208 of A/T client application 101 may block or otherwise modify (block 410) the request. URL tracking module 208 may then permit browser 104 to send (block 412) the modified request to the tracking server.

Another anti-tracking aspect disclosed herein is the use of Referer header field information for tracking purposes. AT&T research has found that personally identifiable information is being leaked to aggregation companies though the Referer header field that is a part of every HTTP request. Embodiments of the A/T client application 101 disclosed herein include a Referer header field tracking module 209 configured to remove or modify the Referer header field in a web request if the header field contains a query string that matches a specified pattern definition or a URL of a listed web aggregator site. For example, Referer header field tracking module 209 may filter personally identifiable information in the Referer header field such as a user id or name on web requests sent to web aggregator domains. Referer header field tracking module 209 may operate in conjunction with referred field data 117 maintained by A/T server application 111 and be refreshed automatically by A/T client application 101, and stored on user device 102 as Referer header field tracking data 219.

Referer header field tracking data 219 may include a Referer header field blacklist, a Referer header field whitelist, and data representing one or more regular expressions used in conjunction with Referer header field tracking module 209. The Referer header field blacklist may identify a list of web sites that are susceptible to Referer header field tracking including, as an example, web sites that reveal personally identifiable information in the address field of a browser when the user is browsing the web site. Some web sites, including many social network web sites, are particularly prone to exhibit this behavior. The Referer header field whitelist may identify a list of web sites expressly approved by the user to engage in Referer header field tracking.

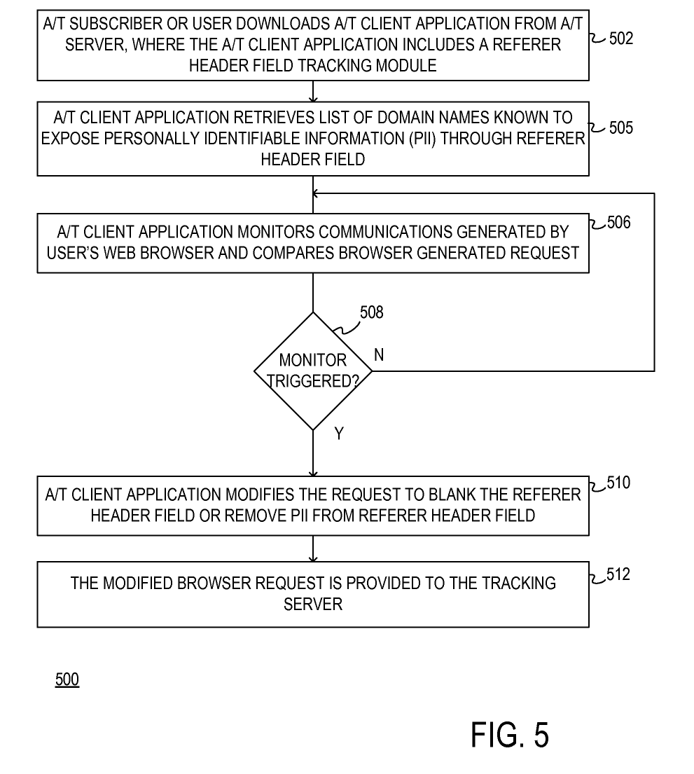

Referring now to FIG. 5, a flow diagram depicts selected elements of an embodiment of a method 500 for implementing disclosed Referer header field anti-tracking measures. In the depicted embodiment of method 500, a user downloads (block 502) A/T client application 101 from A/T server 110, where A/T client application 101 includes a Referer header field tracking module 209. A/T client application 101 periodically retrieves (block 505) or refreshes Referer header field tracking data 219 on user device 102 from Referer header field data 117 maintained by A/T server application 111. Referer header field tracking data 219 may include a list of domain names believed to expose personally identifiable information through Referer header field leakage. Referer header field tracking module 209 of A/T client application 101 monitors (block 506) communications generated by user's web browser and compares browser generated requests against the Referer header field tracking data 219. If Referer header field tracking module 209 detects (block 508) a match in the request based on the Referer header field data, Referer header field tracking module 209 of A/T client application 101 modifies (block 510) the request to blank the Referer header field entirely or remove personally identifiable information from the Referer header field. The modified browser request may then be provided (block 512) to the tracking server by browser 104.

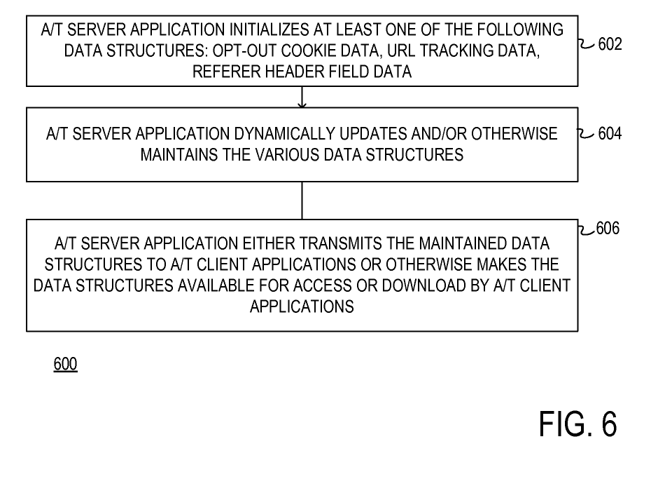

Turning now to FIG. 6, selected aspects of an embodiment of A/T server application 111, are illustrated in flow diagram format. In the depicted embodiment, A/T server application 111 initializes (block 602) one or more of the following data structures: opt-out cookie data 113, URL tracking data 115, and Referer header field data 117. A/T server application 111 may also dynamically update (block 604) and/or otherwise maintain the various data structures. At block 606, A/T server application 111 may transmit or “push” the maintained data structures to A/T client application 101 or otherwise make the data structures available for access or download by A/T client application 101. In addition, some embodiments of A/T server application 111 may make the A/T client application 101 itself available for download to a user device 102. Although the depicted embodiment of A/T server application 111 emphasizes a “download-and-install” implementation, in which the functionality of A/T client application 101 executes on user devices, alternative embodiments may support analogous functionality provided as a network hosted application.

Another aspect disclosed herein is functionality for detecting new opt-out cookies and monitoring URL tracking patterns. As discussed above, web browser cookies and URL tracking are two pervasive methods for implementing tracking. One aspect of subject matter disclosed herein is targeted to assist in the management of these tracking techniques by facilitating rapid identification of consumer opt-out cookies as they become newly available and the discovery of new URL tracking patterns. Subject matter disclosed below supports the detection of URL tracking communications as well as the systematic discovery of web addresses for vendor provided consumer opt-out cookies.

Some embodiments of a disclosed URL tracking detection process implement a web browser rendering engine. The rendering engine is configured to programmatically visit a defined list of top web sites for the purpose of generating web tracking communications that mimic web tracking communications that consumers generate as they browse. The web communications generated by the rendering engine are captured and analyzed for URL tracking using pattern analysis and statistical clustering techniques.

A/T server 110 as depicted in FIG. 1 includes a URL tracking detector 330. Embodiments of URL tracking detector 330 employ a web browser rendering engine 332 to programmatically visit a defined list of web sites. Rendering engine 332 may be configured to process each web page as though it were a conventional web browser. In addition, however, rendering engine 332 may capture and stored all tracking communications that are generated during the programmatic web site visiting.

Browser rendering engine 332 may be configured to process all images, cookies, etc. and allow all scripts to execute. During this processing, all of the communication traffic generated between browser rendering engine 332 and the network may be captured and logged by a collection process of URL tracking detector 330. In execution, as the browser rendering engine 312 visits a defined list of first party sites, the first party sites, represented in FIG. 1 by web server 120, will often direct the browser or HTTP communications to a third party site, represented in FIG. 1 by tracking server 130. URL tracking detector 310 is configured to capture and analyze communications to the third party sites including the content and context of the HTTP message.

Also disclosed is a process for rapidly identifying opt-out cookie URLs. In some embodiments, a web crawler is configured to collect content from Internet web pages known to have or suspected of having opt-out cookie information, either in the form of an actual opt-out cookie or a link to an opt-out cookie. A post processing module is configured to identify opt-out cookie information. The opt-out cookie information might reside in a privacy disclosure page of a web site, a pubic interest web site such as the opt-out pages maintained by the NAI, or another source. The post processing module is configured to capture the definitive URL of a consumer opt-out cookie.

A/T server 110 as depicted in FIG. 1 includes an opt-out cookie search tool 320. Opt-out cookie search tool 320 may include web crawler functionality targeted for discovering web sites that contain opt-out cookies or contain links to web sites that contain opt-out cookies. Search tool 320 may be employed to generate and store opt-out cookie data 113 on A/T server 110 or on a database resource accessible to A/T server 110. Opt-out cookie data 113 may include information identifying all web sites know to contain opt-out cookies and, where appropriate, more specific information indicating the URL of any opt-out cookies included within a web site or domain.

The information generated by these modules can published on a subscription basis or be made available to proprietary tools including, as examples, A/T server application 110 and/or A/T client application 101 discussed previously.

What is claimed is:

1. A tangible computer readable medium comprising computer executable instructions, embedded in the medium, for implementing an anti-tracking service, the instructions comprising instructions for:
refreshing anti-tracking data in an anti-tracking data structure responsive to satisfaction of at least one of a set of anti-tracking refresh criteria, wherein the anti-tracking data includes at least one of: opt-out cookie anti-tracking data indicative of a set of opt-out cookie uniform resource locators (URLs), URL anti-tracking data indicative of a set of URLs associated with URL tracking, and Referer header field anti-tracking data indicative of a set of URLs susceptible to Referer header field tracking;
responsive to a web browser of a user device generating a request for a third-party web page specified by a browser URL, comparing at least a portion of the browser URL against the anti-tracking data; and
responsive to said comparing detecting a match in said URL anti-tracking data or said Referer header field anti-tracking data, modifying the browser URL.

2. The computer readable medium of claim 1, wherein said refreshing comprises pulling a current anti-tracking data structure from an anti-tracking server.

3. The computer readable medium of claim 1, wherein said receiving comprises receiving a current anti-tracking data structure pushed from an anti-tracking server.

4. The computer readable medium of claim 1, wherein at least one of said URL anti-tracking data and said Referer header field anti-tracking data further includes data indicative of a regular expression and wherein said modifying includes modifying the regular expression.

5. The computer readable medium of claim 1, wherein said modifying the regular expression includes modifying portions of the regular expression conveying personally identifiable information.

6. The computer readable medium of claim 1, wherein said URL anti-tracking data includes a URL tracking blacklist of URLs associated with URL tracking and a definitions for a set of regular expression patterns.

7. The computer readable medium of claim 1, further comprising instructions for enabling a user of the user device to specify said anti-tracking refresh criteria.

8. The computer readable medium of claim 7, wherein said criteria data is indicative of at least one of a specified event, the expiration of a specified interval of time, and the arrival of a specified date and time.

9. The computer readable medium of claim 1, wherein the anti-tracking data structure includes a list of opt-out cookie URLs wherein said instructions further comprise instructions for retrieving a current opt-out cookie from a URL corresponding to a match in response to said comparing detecting a match in said opt-out cookie anti-tracking data.

10. The computer readable medium of claim 1, further comprising instructions for enabling the user to provide at least one of a URL tracking whitelist data indicative of a set of URLs authorized by the user and a Referer header field tracking whitelist data indicative of a set of URLs authorized to permit Referer header field tracking and wherein said modifying the browser URL comprises modifying the browser URL unless the said match identifies a URL in one of the URL tracking whitelist data and the Referer header field whitelist data.

11. A user device, comprising:
a processor;
tangible computer readable storage, accessible to the processor; and
instructions, embedded in the storage and executable by the processor, the instructions comprising instructions for:
refreshing, from time to time, anti-tracking data stored on the user device;
monitoring requests generated by a web browser of the user device; and
responsive to detecting a match between at least a portion of the generated request and the anti-tracking data, modifying at least a portion of the generated request.

12. The user device of claim 11, wherein the anti-tracking data includes uniform resource locator (URL) tracking data indicative of web sites that participate in URL tracking.

13. The user device of claim 12, wherein said modifying comprises modifying a portion of the generated request containing personally identifiable information.

14. The user device of claim 12, wherein said monitoring includes monitoring a domain portion of the contents of the address field for a match against domains indicated in the URL tracking data and monitoring a query portion of the address field for a match against regular expressions indicated in the URL tracking data.

15. The user device of claim 11, wherein the anti-tracking data includes Referer header field tracking data indicative of web sites that participate in Referer header field tracking.

16. The user device of claim 15, wherein said modifying comprises modifying a portion of the generated request containing personally identifiable information.

17. The user device of claim 15, wherein said monitoring includes monitoring a domain portion of the contents of the address field for a match against domains indicated in the Referer header field tracking data and monitoring a query portion of the address field for a match against regular expressions indicated in the Referer header field tracking data.

18. A method of providing anti-tracking services for a user device, comprising:
initiating, by the user device, a refresh of anti-tracking data stored on the user device;
monitoring web requests generated by a user device browser including comparing uniform resource locator (URL) information in a web request generated by a user device browser to URL information in the anti-tracking data; and
modifying the web request when the URL information matches URL information in the anti-tracking data.

19. The method of claim 18, wherein the anti-tracking data comprises opt-out cookie data indicative of a set of opt-out cookies, URL tracking data indicative of a set of web sites associated with URL tracking, and Referer header field tracking data indicative of a set of web sites associated with Referer header field tracking.

20. The method of claim 18, wherein modifying the web request includes modifying based on a match between a character string expression in a query portion of the web request and a regular expression pattern definition in the anti-tracking data.
